(19) United States
(12) Patent Application Publication
(10) Pub. No.: US 2024/0253026 A1
(43) Pub. Date: Aug. 1, 2024

(54) CORE-SHELL CATALYST WITH IMPROVED DURABILITY AND MANUFACTURING METHOD THEREOF

(71) Applicant: KOREA INSTITUTE OF ENERGY RESEARCH, Daejeon (KR)

(72) Inventors: Gu-Gon PARK, Daejeon (KR); Eunjik LEE, Sejong-si (KR); Sung-Dae YIM, Daejeon (KR); Seok-Hee PARK, Daejeon (KR); Minjin KIM, Daejeon (KR); Young-Jun SOHN, Daejeon (KR); Byungchan BAE, Daejeon (KR); Seung-Gon KIM, Daejeon (KR); Dongwon SHIN, Sejong-si (KR); Seung Wook CHOI, Daejeon (KR); Hwangyeong OH, Daejeon (KR); Seung Hee WOO, Daejeon (KR); So Jeong LEE, Daejeon (KR); Hyejin LEE, Daejeon (KR); Yoon Young CHOI, Sejong-si (KR); Yun Sik KANG, Seongnam-si (KR); Won-Yong LEE, Daejeon (KR); Tae-Hyun YANG, Daejeon (KR)

(73) Assignee: KOREA INSTITUTE OF ENERGY RESEARCH, Daejeon (KR)

(21) Appl. No.: 18/412,426

(22) Filed: Jan. 12, 2024

(30) Foreign Application Priority Data
Jan. 27, 2023 (KR) 10-2023-0011025

(51) Int. Cl. B01J 37/02; B01J 35/00; B01J 37/08; B01J 37/16; B01J 37/34

(52) U.S. Cl. CPC B01J 37/0221; B01J 35/19; B01J 37/08; B01J 37/16; B01J 37/343

(57) ABSTRACT

Provided are a core-shell catalyst with improved durability and a manufacturing method thereof including irradiating ultrasonic waves to a solution containing a reducing solvent, a noble metal precursor, a transition metal precursor, and a carbon support to form a cavity due to the irradiation of the ultra-waves and forming transition metal precursor core and noble metal precursor shell particles due to a difference in vapor pressure; and nitriding the transition metal precursor core and noble metal precursor shell particles at a temperature of 450 to 550° C. and a pressure condition of 60 to 100 bar under a gaseous nitrogen source, in which the transition metal may be any one selected from the group consisting of Y, La, Ce, Zn, and Mn or combinations thereof.

### CROSS-REFERENCE TO RELATED APPLICATIONS

This application claims the priority of Korean Patent Application No. 10-2023-0011025 filed on Jan. 27, 2023, in the Korean Intellectual Property Office, the disclosure of which is incorporated herein by reference.

### BACKGROUND

### Field

The present disclosure relates to a core-shell catalyst with improved durability and a manufacturing method thereof.

### Description of the Related Art

In general, a fuel cell, which is in the spotlight as a next-generation energy source, is a device that directly converts chemical energy generated by oxidation/reduction of fuel into electrical energy, and recently, the fuel cell is expected to be a future electric power source for transportation such as electric vehicles and for power supply at home. The electrode reaction in the fuel cell consists of a hydrogen oxidation reaction at a cathode and an oxygen reduction reaction at an anode, but in a fuel cell system that operates at a low temperature, such as a polymer electrolyte membrane fuel cell and the like, in order for these electrochemical reactions to actually occur smoothly, the reaction rate needs to be effectively increased.

For these reasons, platinum (Pt), a noble metal catalyst, has been inevitably used in conventional fuel cell systems. However, despite showing excellent energy conversion efficiency, the platinum catalyst is very expensive and has limited reserves, which may be a problem in the popularization of fuel cells. In particular, the need for a novel electrode catalyst with high efficiency and low cost was the most urgent problem related to a polymer electrolyte membrane fuel cell (PEMFC). In order to solve the obstacles and promote commercialization of the fuel cell, recently, multi-component nanoparticles, including a plurality of components such as alloy nanoparticles and core-shell nanoparticles, have been studied to replace a platinum catalyst supported on a current carbon support. The method is cumbersome and uneconomical in synthesis and has a disadvantage of an inevitable increase in particle size and loss of a surface area with catalytic activity. In particular, a technology has been developed to minimize deterioration of catalytic performance compared to the platinum catalyst by consisting of a transition metal-based core and a platinum-based shell. However, in this case, there is a disadvantage in that the durability of the catalyst is limited due to reduced durability of the catalyst, and in order to improve this disadvantage, a nitrogen injection technology also has a limit to the content of nitrogen to be injected into the core portion. In addition, in the prior art, the manufacturing is performed sequentially by manufacturing the core and then adding nitrogen to the core and coating the shell, and thus, there is a disadvantage that since the core and the shell are not manufactured continuously, the shell thickness is not uniform, and the manufacturing process is complicated and takes a lot of time.

In this regard, in the prior art, in Korea Patent Registration No. 1468113, there are disclosed “apparatus and method for manufacturing gas-phase core-shell nanoparticles using electron beam irradiation at room temperature and atmospheric pressure” (hereinafter referred to as Prior Art 1).

Prior Art 1 relates to apparatus and method for manufacturing gas-phase core-shell nanoparticles using electron beam irradiation at room temperature and atmospheric pressure by providing a shell material precursor generator, a core material precursor generator, and a particle coating reactor. Prior Art 1 was a technology including a shell material precursor generator that generates a shell material precursor by a working fluid, a core material generator that generates a core material by a working fluid, a particle coating reactor that forms core-shell nanoparticles with the shell material precursor and the core material introduced from the shell material precursor generator and the core material generator, and a particle collector that collects the core-shell nanoparticles generated from the particle coating reactor.

In addition, Prior Art 1 was a technology of using the manufacturing apparatus and the manufacturing method of the gas-phase core-shell nanoparticles using electron beam irradiation at room temperature and atmospheric pressure, thereby not only easily manufacturing core-shell nanoparticles by generating core nanoparticles in the core material generator by the working fluid while operating all the devices at room temperature and atmospheric pressure and generating the shell material precursor steam in the shell material precursor generator by the working fluid, but also minimizing the manufacturing apparatus and reducing the costs because there is no need for a high pressure device.

Meanwhile, in the prior art, in Korean Patent Publication No. 2013-0039456, there are disclosed “a nitrogen-doped core-shell nanocatalyst and a preparation method thereof” (hereinafter referred to as Prior Art 2).

Prior Art 2 provides an electrode catalyst for a fuel cell and a preparation method thereof, and more specifically, provides an electrode catalyst for a fuel cell including a nitrogen-doped metal or metal oxide core and a carbon shell (metal or metal oxide@C—N) as active ingredients, and a preparation method of the electrode catalyst for the fuel cell including (i) a first step of preparing a metal or metal oxide core and a carbon shell; and a second step of doping the metal or metal oxide core and the carbon shell with nitrogen. The electrode catalyst for the fuel cell was a non-platinum catalyst and a technology that is not only easy to commercialize due to its low production cost, but also can improve the efficiency and durability of the fuel cell due to its excellent catalytic activity and good durability against oxidation-reduction reactions.

In addition, in the prior art, in Korean Patent Publication No. 2022-0033545, there are disclosed “apparatus and method for manufacturing core-shell particles using carbon monoxide by laser ablation (hereinafter, referred to as Prior Art 3).

Prior Art 3 relates to a method for manufacturing core-shell particles using carbon monoxide, and more particularly, to a method for manufacturing core-shell particles that includes adsorbing carbon monoxide on transition metal for a core; and forming particles of a core-shell structure in which a reduced metal shell layer is formed on the transition metal core by reacting the carbon monoxide adsorbed on the surface of the transition metal for the core with a metal precursor for a shell and a solvent. Accordingly, the particles can be prepared through a simple and fast one-pot reaction to reduce process costs, facilitate scale-up, and change various types of core and shell metals and form a multi-layered shell.

In addition, in the prior art, in Korean Patent Publication No. 2022-0033549, there are disclosed “method and apparatus for manufacturing a metal thin film using carbon monoxide” (hereinafter, referred to as Prior Art 4).

Prior Art 4 relates to a manufacturing method of core-shell particles using carbon monoxide, and more specifically, a technology including adsorbing carbon monoxide on a transition metal for a core; preparing a composition for forming a thin film having particles of a core-shell structure in which carbon monoxide adsorbed on the surface of the transition metal for the core reacts with a metal precursor for a shell and a solvent to form a reduced metal shell layer on the transition metal core, applying the composition for forming the thin film to a substrate; and heat-treating the applied composition for forming the thin film under reduced pressure.

In addition, Prior Art 4 relates to a manufacturing method and a manufacturing apparatus of a thin film with a core-shell particle structure in which the disclosed thin film includes a thin film layer having a thickness of greater than 50 Å to 20000 Å or less and a refractive index of 1.85 to 2.0, and particles can be prepared through a simple and fast one-pot reaction to reduce process costs, facilitate scale-up, and change various types of core and shell metals and form a multi-layered shell.

In addition, in the prior art, in Korean Patent Publication No. 2022-0049500, there is disclosed “a method for controlling sizes of core-shell nanoparticles” (hereinafter, referred to as Prior Art 5).

Prior Art 5 relates to a method for controlling sizes of core-shell nanoparticles, and more particularly, to a method for controlling sizes of core-shell nanoparticles which includes preparing a slurry by irradiating ultrasonic waves to a dispersion containing a reducing solvent, a carbon support, a transition metal precursor, and a noble metal precursor; preparing a solid by filtering the prepared slurry and then washing and drying the filtered slurry; and preparing nanoparticles by heat-treating the dried solid in an N₂ atmosphere at a pressure of 1 to 80 bar and a temperature of 450 to 600° C. for 30 minutes to 10 hours. Accordingly, it is possible to have excellent stability (durability), small average diameters, and excellent dispersion and uniformity without performing a complicated post-treatment process for removing a protective layer used during conventional heat treatment.

In addition, in the prior art, in Korean Patent Publication No. 2010-0119833, there are disclosed “a nano support having a core/shell structure for a catalyst electrode for a fuel cell and a manufacturing method thereof” (hereinafter referred to as Prior Art 6).

Prior Art 6 relates to a nano support having a core/shell structure for a catalyst electrode for a fuel cell and a manufacturing method thereof, and more particularly, to a catalyst electrode for a fuel cell and a manufacturing method thereof so as to develop a new support, TiN@C, and a catalyst electrode structure by heat-treating titanium nitride (TiN) in a carbonization atmosphere to adjust electrical conductivity and nanostructures with a core/shell nanostructure that coats the outer shell with carbon in existing TiN.

Prior Art 6 was a technology for providing a catalyst electrode for a fuel cell, in which a core/shell in which titanium nitride was coated with carbon like a shell through heat treatment was used as a catalyst support for a nanomaterial.

In addition, in the prior art, in Korean Patent Publication No. 2019-0063290, there is disclosed “a method for controlling sizes of core-shell nanoparticles” (hereinafter, referred to as Prior Art 7).

Prior Art 7 relates to a manufacturing method of a liquid-phase vaporized core-shell catalyst, and more particularly, to a manufacturing method of a liquid-phase nitrided core-shell catalyst which includes nitriding a nitrogen source combined with a transition metal precursor in one reactor, while forming a transition metal precursor core and noble metal precursor shell particles due to a difference in vapor pressure by irradiating ultrasonic waves to a solution containing a liquid nitrogen source, a reducing solvent, a noble metal precursor, a transition metal precursor, and a carbon support to form a cavity due to the irradiation of the ultrasonic waves. Accordingly, the nitrogen content of the core can be easily controlled, and a high level of nitriding can be performed through an easy single process, so that the manufactured catalyst is suitable for a fuel cell field due to excellent durability, small average particle size, and high dispersion and uniformity.

In addition, in the prior art, in Korean Patent Publication No. 2013-0123217, there are disclosed “a nanoparticle having a core/shell structure and a preparing method thereof” (hereinafter, referred to as Prior Art 8).

Prior Art 8 was a technology capable of preparing core/shell structure nanoparticles in which an internal elemental distribution, a nanoparticle shape, and a shell thickness can be easily and economically controlled by using an ultrasonic irradiation method and a difference in vapor pressure between metal precursors used to prepare the core/shell structured nanoparticles of the present application. That is, Prior Art 8 was a technology that provides core/shell structured nanoparticles of which an elemental distribution is controlled by using an ultrasonic irradiation method, an electrode catalyst containing the core/shell structured nanoparticles, and a manufacturing method of the core/shell structured nanoparticles.

Meanwhile, the lifespan of a fuel cell stack aims to at least 10,000 operation/stop repeats for at least 5,000 hours of operating time, but it is known that there is a significant difference from a current technology level. Causes of performance reduction in polymer electrolyte fuel cells may include pollutants in the air, insufficient supply of reaction gas during operation, periodic repetition of operation and stop, deterioration of a catalyst, degradation of an electrolyte membrane, imperfect operating conditions, and the like, and among the causes, the deterioration of the catalyst is known as one of main causes.

In order to solve these problems of the prior art, technologies capable of preventing the deterioration of the catalyst due to high durability have been researched and developed.

That is, iron, cobalt, nickel, copper, etc. are already known to have good catalytic performance when alloyed with platinum, and yttrium, etc., are difficult to be alloyed (but has high durability when alloyed) and easily oxidized to be very difficult to be made into a core (since an oxidation-reduction potential is low, the tendency to form an oxide is very strong, and thus metal alloying is very difficult). In the related art, there have been some studies on methods of making alloys using ionic liquids or vacuum methods to alloy metals such as yttrium and the like, but there have been no cases of alloying and nitriding these metals. The present inventors found through the studies that ligands bound to the transition metal precursor were broken and reduced using ultrasonic waves to make yttrium, etc. into the core, and invented a novel core-shell catalyst with significantly high durability by nitriding the metals and a manufacturing method thereof.

### SUMMARY

Accordingly, in order to improve the problems, an object of the present disclosure is to provide an efficient manufacturing method for a core-shell catalyst consisting of a non-noble metal core and a platinum shell, and in particular, having improved durability of the catalyst.

To this end, an object of the present disclosure is to provide a core-shell catalyst with improved durability capable of containing a higher content of nitrogen in a core compared to the prior art, and a manufacturing method thereof.

In addition, in the core-shell catalyst and the manufacturing method thereof according to the present disclosure, an object of the present disclosure is to provide a method of manufacturing a core-shell catalyst with improved durability capable of improving the uniformity of the core and the shell without increasing an average particle size of the catalyst even while nitrogen is included in the core.

In addition, in the core-shell catalyst and the manufacturing method thereof according to the present disclosure, an object of the present disclosure is to obtain core-shell catalyst particles with improved durability by nitriding core-shell catalyst particles prepared using Y, La, Ce, Zn, and Mn as a core metal that had been not used as the core transition metal in an existing core-shell catalyst.

According to an aspect of the present disclosure, there are provided a core-shell catalyst with improved durability and a manufacturing method thereof, including irradiating ultrasonic waves to a solution containing a reducing solvent, a noble metal precursor, a transition metal precursor, and a carbon support to form a cavity due to the irradiation of the ultra-waves and forming transition metal precursor core and noble metal precursor shell particles due to a difference in vapor pressure; and nitriding the transition metal precursor core and noble metal precursor shell particles at a temperature of 450 to 900° C. and a pressure condition of 1 to 120 bar under a gaseous nitrogen source, in which the transition metal may be any one selected from the group consisting of Y, La, Ce, Zn, and Mn or combinations thereof.

During the nitriding, the nitriding is performed preferably at a nitriding temperature of 450 to 900° C. and a pressure condition of 1 to 120 bar. When the temperature is less than 450° C., there may be a problem in that nitriding does not occur in the catalyst particles, and when the temperature is more than 900° C., there may be problems of reducing a catalytic active area and decreasing a nitriding level due to particle aggregation. In addition, in the pressure condition, when the pressure is less than 1 bar, the nitriding level in the catalyst particles is quite low, causing a problem in securing durability, and when the pressure is 120 bar or more, a problem in increased manufacturing cost may occur due to additional costs and safety problems depending on a design/material of a high-pressure reactor.

In the core-shell catalyst with improved durability and the manufacturing method thereof according to the exemplary embodiment of the present disclosure, the gaseous nitrogen source may be selected from the group consisting of ammonia, urea, and melamine.

In the core-shell catalyst with improved durability and the manufacturing method thereof according to the exemplary embodiment of the present disclosure, the particle size of the core-shell catalyst may be 3 nm to 5 nm.

In the core-shell catalyst with improved durability and the manufacturing method thereof according to the exemplary embodiment of the present disclosure, the core-shell particle may contain 0.45 to 1.11 wt % of nitrogen.

In the core-shell catalyst with improved durability and the manufacturing method thereof according to the exemplary embodiment of the present disclosure, the core-shell particle may contain preferably 30 to 90 wt %, most preferably 57.79 to 59.97 wt % of carbon. When the carbon content is less than 30 wt %, there is a problem in that a distance between the supported catalyst particles is short, and thus the catalyst particles are easily aggregated when operating the fuel cell and the catalytic active area is greatly reduced. When the carbon content is more than 90 wt %, a lot of carbon is exposed to the electrode surface, and thus deterioration problems may occur due to carbon corrosion that occurs while operating the fuel cell.

In the core-shell catalyst with improved durability and the manufacturing method thereof according to the exemplary embodiment of the present disclosure, the core-shell particle may contain 0.16 to 0.31 wt % of hydrogen.

In the core-shell catalyst with improved durability and the manufacturing method thereof according to the exemplary embodiment of the present disclosure, the core-shell particle may contain 0.20 to 0.25 wt % of sulfur (S).

In the core-shell catalyst with improved durability and the manufacturing method thereof according to the exemplary embodiment of the present disclosure, the core-shell particle may contain 1.82 to 4.18 wt % of oxygen.

In the core-shell catalyst with improved durability and the manufacturing method thereof according to the exemplary embodiment of the present disclosure, the carbon support may be a porous carbon support.

In the core-shell catalyst with improved durability and the manufacturing method thereof according to the exemplary embodiment of the present disclosure, the core-shell catalyst may be a platinum shell.

In the core-shell catalyst with improved durability and the manufacturing method thereof according to the exemplary embodiment of the present disclosure, the core-shell catalyst may have a ratio (M/N Ratio) of a transition metal and nitrogen of 0.3 to 1.3.

In the core-shell catalyst with improved durability and the manufacturing method thereof according to the exemplary embodiment of the present disclosure, the core-shell catalyst may have a reduction rate in electrochemical surface area (ECSA) lower than that of a commercial platinum catalyst after evaluation of accelerated durability (0.6 V (3 s) to 0.95 V (3 s), 10,000 cycles).

In the core-shell catalyst with improved durability and the manufacturing method thereof according to the exemplary embodiment of the present disclosure, the core-shell catalyst may have a reduction rate in mass activity (MA) lower than that of a commercial platinum catalyst after evaluation of accelerated durability (0.6 V (3 s) to 0.95 V (3 s), 10,000 cycles).

In the core-shell catalyst with improved durability and the manufacturing method thereof according to the exemplary embodiment of the present disclosure, the core-shell catalyst may have a reduction rate in half wave potential (E ½) lower than that of a commercial platinum catalyst after evaluation of accelerated durability (0.6 V (3 s) to 0.95 V (3 s), 10,000 cycles).

A core-shell catalyst with improved durability according to another exemplary embodiment of the present disclosure includes a noble metal shell surrounding the transition metal core, in which the transition metal core may be any one selected from the group consisting of Y, La, Ce, Zn, and Mn.

In the core-shell catalyst with improved durability according to another exemplary embodiment of the present disclosure, the core-shell catalyst may be nitrided to improve durability.

In the core-shell catalyst with improved durability according to another exemplary embodiment of the present disclosure, the particle size of the core-shell catalyst may be 3 nm to 5 nm.

In the core-shell catalyst with improved durability according to another exemplary embodiment of the present disclosure, the core-shell particle may contain 0.45 to 1.11 wt % of nitrogen.

In the core-shell catalyst with improved durability according to another exemplary embodiment of the present disclosure, the core-shell particle may contain preferably 30 to 90 wt %, most preferably 57.79 to 59.97 wt % of carbon. When the carbon content is less than 30 wt %, there is a problem in that a distance between the supported catalyst particles is short, and thus the catalyst particles are easily aggregated when operating the fuel cell and the catalytic active area is greatly reduced. When the carbon content is more than 90 wt %, a lot of carbon is exposed to the electrode surface, and thus deterioration problems may occur due to carbon corrosion that occurs while operating the fuel cell.

In the core-shell catalyst with improved durability according to another exemplary embodiment of the present disclosure, the core-shell particle may contain 0.16 to 0.31 wt % of hydrogen.

In the core-shell catalyst with improved durability according to another exemplary embodiment of the present disclosure, the core-shell particle may contain 0.20 to 0.25 wt % of sulfur (S).

In the core-shell catalyst with improved durability according to another exemplary embodiment of the present disclosure, the core-shell particle may contain 1.82 to 4.18 wt % of oxygen.

In the core-shell catalyst with improved durability according to another exemplary embodiment of the present disclosure, the carbon support may be a porous carbon support.

In the core-shell catalyst with improved durability according to another exemplary embodiment of the present disclosure, the core-shell catalyst may be a platinum shell.

In the core-shell catalyst with improved durability according to another exemplary embodiment of the present disclosure, the core-shell catalyst may have a ratio (M/N Ratio) of a transition metal and nitrogen of 0.3 to 1.3.

In the core-shell catalyst with improved durability according to another exemplary embodiment of the present disclosure, the core-shell catalyst may have a reduction rate in electrochemical surface area (ECSA) lower than that of a commercial platinum catalyst after evaluation of accelerated durability (0.6 V (3 s) to 0.95 V (3 s), 10,000 cycles).

In the core-shell catalyst with improved durability according to another exemplary embodiment of the present disclosure, the core-shell catalyst may have a reduction rate in mass activity (MA) lower than that of a commercial platinum catalyst after evaluation of accelerated durability (0.6 V (3 s) to 0.95 V (3 s), 10,000 cycles).

In the core-shell catalyst with improved durability according to another exemplary embodiment of the present disclosure, the core-shell catalyst may have a reduction rate in half wave potential (E ½) lower than that of a commercial platinum catalyst after evaluation of accelerated durability (0.6 V (3 s) to 0.95 V (3 s), 10,000 cycles).

According to the present disclosure, the core-shell catalyst with improved durability manufactured by nitriding has a high nitrogen content in the core to have a small average particle size and high dispersion and uniformity while having excellent durability of the prepared catalyst.

Further, the core-shell catalyst with improved durability manufactured by nitriding may be obtained in large quantities because the production process is easy.

Accordingly, the core-shell catalyst of the present disclosure is expected to contribute greatly to the commercialization of fuel cells when applied as an electrode catalyst with high oxygen reduction reaction efficiency.

Further, the present disclosure has an advantage that the nitrided core-shell catalyst has a lower reduction rate in catalytic performance than a commercial platinum catalyst even after evaluation of durability to have very high durability of the core-shell catalyst.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 illustrates a manufacturing method of a core-shell catalyst with improved durability according to an exemplary embodiment of the present disclosure;

FIGS. 2 to 6 illustrate XRD analysis results of a core-shell catalyst with improved durability according to an exemplary embodiment of the present disclosure;

FIG. 7 illustrates a structural analysis result of a core-shell catalyst with improved durability according to an exemplary embodiment of the present disclosure;

FIG. 8 illustrates a catalytic analysis result of a core-shell catalyst with improved durability according to an exemplary embodiment of the present disclosure;

FIGS. 9 to 12 illustrate particle size uniformity and dispersion of a core-shell catalyst with improved durability according to an exemplary embodiment of the present disclosure; and

FIGS. 13 to 25 illustrate catalyst performance and durability evaluation results of a core-shell catalyst with improved durability according to an exemplary embodiment of the present disclosure.

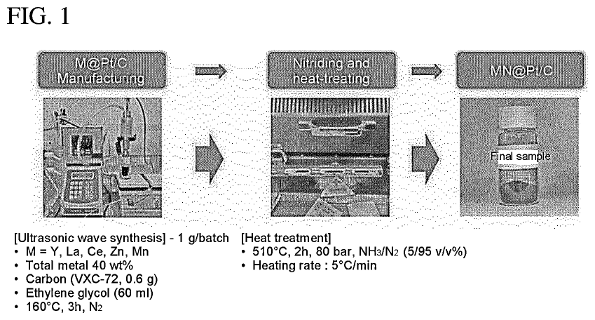

### DETAILED DESCRIPTION OF THE PREFERRED EMBODIMENT

Hereinafter, exemplary embodiments of the present disclosure will be described in detail so as to be easily implemented by those skilled in the art, with reference to the accompanying drawings. A description of the present disclosure is merely an exemplary embodiment for a structural or functional description and the scope of the present disclosure should not be construed as being limited by exemplary embodiments described in a text. That is, since the exemplary embodiment can be variously changed and have various forms, the scope of the present disclosure should be understood to include equivalents capable of realizing the technical spirit. Further, since it does not mean that a specific exemplary embodiment should include all objects or effects or include only the effect, it should not be understood that the scope of the present disclosure is limited by the object or effect.

Meanings of terms described in the present disclosure should be understood as follows.

The terms “first”, “second”, and the like are used to differentiate a certain component from other components, but the scope of the present disclosure should not be construed to be limited by the terms. For example, a first component may be referred to as a second component, and similarly, the second component may be referred to as the first component. It should be understood that, when it is described that a component is “connected to” the other component, the component may be directly connected to the other component, or another component may be present therebetween. In contrast, it should be understood that when it is described that a component is “directly connected to” the other component, another component is not present therebetween. Meanwhile, other expressions describing the relationship between the components, that is, expressions such as “between” and “directly between” or “adjacent to” and “directly adjacent to” should be similarly interpreted.

It is to be understood that the singular expression encompasses a plurality of expressions unless the context clearly dictates otherwise and it should be understood that term such as “including” or “having” indicates that a feature, a number, a step, an operation, a component, a part or the combination thereof described in the specification is present, but does not exclude a possibility of presence or addition of one or more other features, numbers, steps, operations, components, parts or combinations thereof, in advance.

If it is not contrarily defined, all terms used herein have the same meanings as those generally understood by those skilled in the art. Terms which are defined in a generally used dictionary should be interpreted to have the same meaning as the meaning in the context of the related art and are not interpreted as an ideal meaning or excessively formal meanings unless clearly defined in the present disclosure.

### Manufacturing Method of Core-Shell Catalyst

Hereinafter, preferred Exemplary Embodiments of the present disclosure will be provided in order to facilitate understanding of the present disclosure. It will be apparent to those skilled in the art, however, that the following Exemplary Embodiments are only illustrative of the present disclosure and various changes and modifications can be made within the scope and spirit of the present disclosure, and that these variations and modifications are within the scope of the appended claims.

### Exemplary Embodiment 1

Platinum acetylacetonate (Aldrich) powder, yttrium (Y) powder, and a carbon support (Vulcan XC72) were added to ethylene glycol, a reducing solvent, and in this state, ultrasonic waves were irradiated for 3 hours at a high temperature of 160° C. under a nitrogen source atmosphere using a high-intensity ultrasonic probe (Sonic and Materials, model VC-500, amplitude 30%, 13 mm solid probe, 20 kHz). The reaction temperature was naturally controlled by balancing heat generated by ultrasonic waves and a heat loss rate. A solid product obtained as a result of ultrasonic irradiation was purified, washed with ethanol, and dried under a vacuum atmosphere. Thereafter, the prepared solid product was nitrided and heat-treated using gaseous N₂ (95%) and NH₃ (5%) at a temperature of 510° C. and a pressure condition of 80 bar to prepare a core-shell catalyst (YN@Pt/C), and the detailed mixing ratio was shown in Table 1 below.

TABLE 1

| | | Metal | Metal | Carbon | Total |
|---|---|---|---|---|---|
| Sample | Metal | (g) | (mol) | (g) | (g) |
| YN@Pt/C | Pt | 0.356 | 0.00183 | 0.655 | 1.092 |
| | Y | 0.0812 | 0.000914 | | |

### Exemplary Embodiment 2

Platinum acetylacetonate (Aldrich) powder, lanthanum (La) powder, and a carbon support (Vulcan XC72) were added to ethylene glycol, a reducing solvent, and in this state, ultrasonic waves were irradiated for 3 hours at a high temperature of 160° C. under a nitrogen source atmosphere using a high-intensity ultrasonic probe (Sonic and Materials, model VC-500, amplitude 30%, 13 mm solid probe, 20 kHz). The reaction temperature was naturally controlled by balancing heat generated by ultrasonic waves and a heat loss rate. A solid product obtained as a result of ultrasonic irradiation was purified, washed with ethanol, and dried under a vacuum atmosphere. Thereafter, the prepared solid product was nitrided and heat-treated using gaseous N₂ (95%) and NH₃ (5%) at a temperature of 510° C. and a pressure condition of 80 bar to prepare a core-shell catalyst (LaN@Pt/C), and the detailed mixing ratio was shown in Table 2 below.

TABLE 2

| | | Metal | Metal | Carbon | Total |
|---|---|---|---|---|---|
| Sample | Metal | (g) | (mol) | (g) | (g) |
| LaN@Pt/C | Pt | 0.326 | 0.00167 | 0.655 | 1.097 |
| | La | 0.116 | 0.000836 | | |

### Exemplary Embodiment 3

Platinum acetylacetonate (Aldrich) powder, cerium (Ce) powder, and a carbon support (Vulcan XC72) were added to ethylene glycol, a reducing solvent, and in this state, ultrasonic waves were irradiated for 3 hours at a high temperature of 160° C. under a nitrogen source atmosphere using a high-intensity ultrasonic probe (Sonic and Materials, model VC-500, amplitude 30%, 13 mm solid probe, 20 kHz). The reaction temperature was naturally controlled by balancing heat generated by ultrasonic waves and a heat loss rate. A solid product obtained as a result of ultrasonic irradiation was purified, washed with ethanol, and dried under a vacuum atmosphere. Thereafter, the prepared solid product was nitrided and heat-treated using gaseous N₂ (95%) and NH₃ (5%) at a temperature of 510° C. and a pressure condition of 80 bar to prepare a core-shell catalyst (Ce@Pt/C), and the detailed mixing ratio was shown in Table 3 below.

TABLE 3

| | | Metal | Metal | Carbon | Total |
|---|---|---|---|---|---|
| Sample | Metal | (g) | (mol) | (g) | (g) |
| CeN@Pt/C | Pt | 0.345 | 0.00177 | 0.655 | 1.124 |
| | Ce | 0.124 | 0.000882 | | |

### Exemplary Embodiment 4

Platinum acetylacetonate (Aldrich) powder, zinc (Zn) powder, and a carbon support (Vulcan XC72) were added to ethylene glycol, a reducing solvent, and in this state, ultrasonic waves were irradiated for 3 hours at a high temperature of 160° C. under a nitrogen source atmosphere using a high-intensity ultrasonic probe (Sonic and Materials, model VC-500, amplitude 30%, 13 mm solid probe, 20 kHz). The reaction temperature was naturally controlled by balancing heat generated by ultrasonic waves and a heat loss rate. A solid product obtained as a result of ultrasonic irradiation was purified, washed with ethanol, and dried under a vacuum atmosphere. Thereafter, the prepared solid product was nitrided and heat-treated using gaseous N₂ (95%) and NH₃ (5%) at a temperature of 510° C. and a pressure condition of 80 bar to prepare a core-shell catalyst (Zn@Pt/C), and the detailed mixing ratio was shown in Table 4 below.

TABLE 4

| | | Metal | Metal | Carbon | Total |
|---|---|---|---|---|---|
| Sample | Metal | (g) | (mol) | (g) | (g) |
| ZnN@Pt/C | Pt | 0.374 | 0.0192 | 0.655 | 1.093 |
| | Zn | 0.0632 | 0.000967 | | |

### Exemplary Embodiment 5

Platinum acetylacetonate (Aldrich) powder, manganese (Mn) powder, and a carbon support (Vulcan XC72) were added to ethylene glycol, a reducing solvent, and in this state, ultrasonic waves were irradiated for 3 hours at a high temperature of 160° C. under a nitrogen source atmosphere using a high-intensity ultrasonic probe (Sonic and Materials, model VC-500, amplitude 30%, 13 mm solid probe, 20 kHz). The reaction temperature was naturally controlled by balancing heat generated by ultrasonic waves and a heat loss rate. A solid product obtained as a result of ultrasonic irradiation was purified, washed with ethanol, and dried under a vacuum atmosphere. Thereafter, the prepared solid product was nitrided and heat-treated using gaseous N₂ (95%) and NH₃ (5%) at a temperature of 510° C. and a pressure condition of 80 bar to prepare a core-shell catalyst (Mn@Pt/C), and the detailed mixing ratio was shown in Table 5 below.

TABLE 5

| | | Metal | Metal | Carbon | Total |
|---|---|---|---|---|---|
| Sample | Metal | (g) | (mol) | (g) | (g) |
| MnN@Pt/C | Pt | 0.389 | 0.00199 | 0.655 | 1.099 |
| | Mn | 0.0549 | 0.000999 | | |

### Comparative Embodiment 1

Commercial catalyst of Pt/C (Johnson Matthey Co., Ltd., HiSpec4000 product)

### Experimental Embodiment 1. XRD Analysis Results by Manufacturing Process of M@Pt/C (M=Y, La, Ce, Zn, Mn) Catalyst

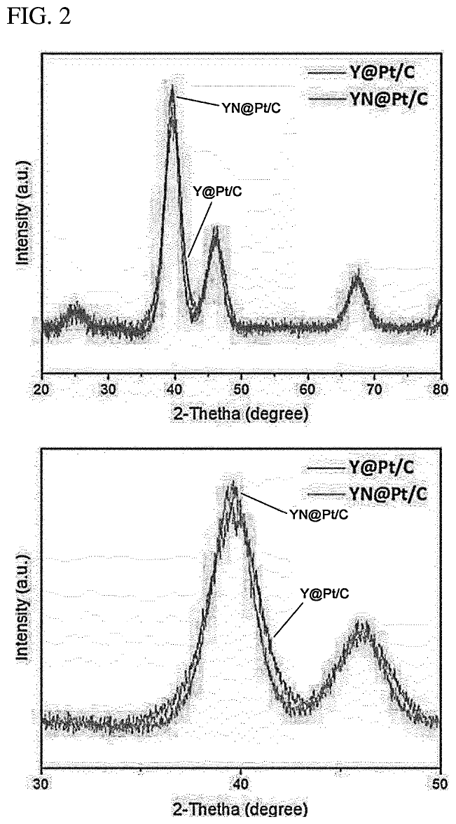

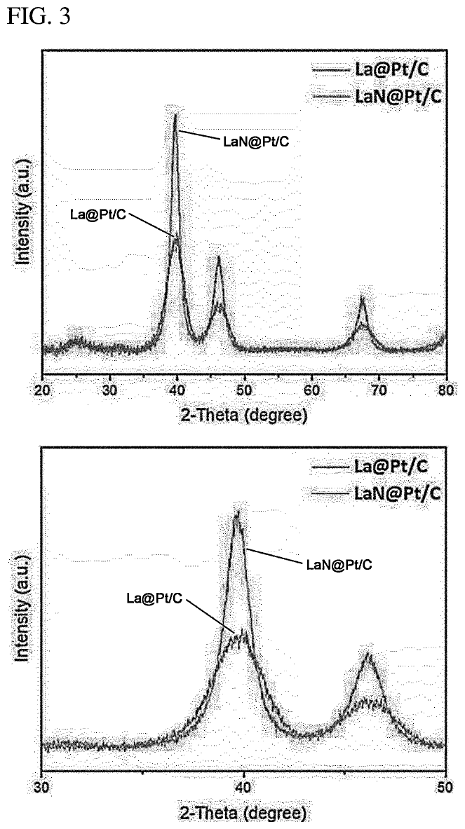

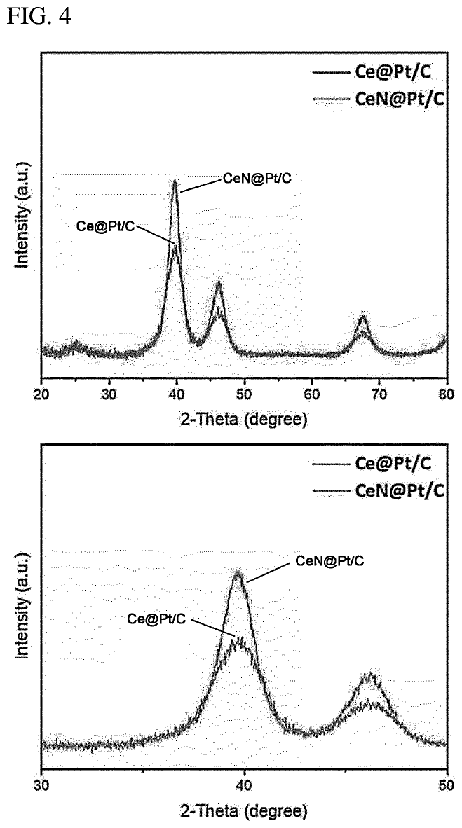

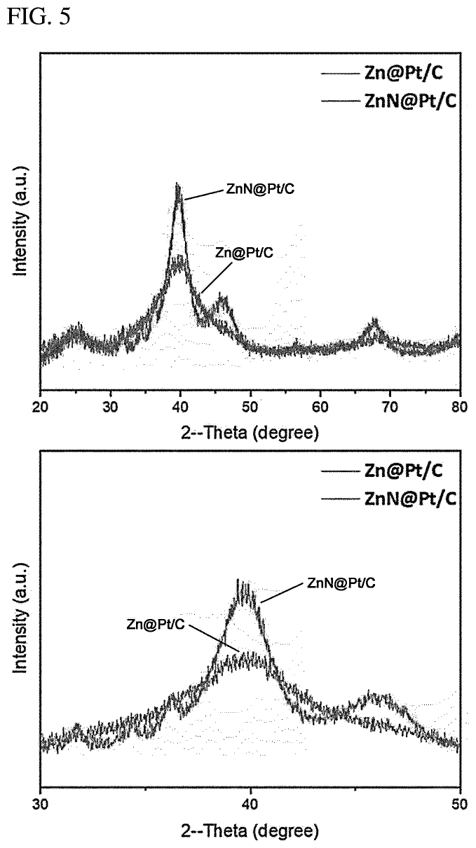

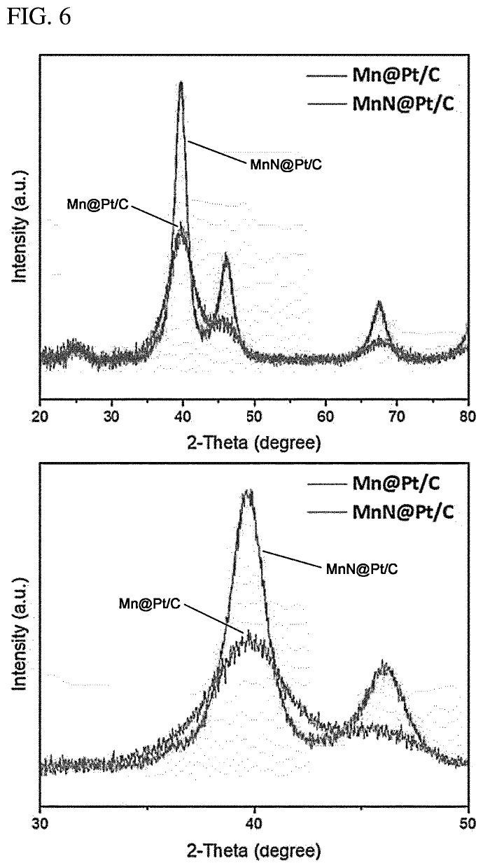

FIGS. 2 to 6 illustrate XRD analysis results of a core-shell catalyst with improved durability according to an exemplary embodiment of the present disclosure.

Referring to FIGS. 2 to 6, the core-shell catalyst with improved durability of the present disclosure used Y, La, Ce, Zn, and Mn as transition metals, and as a result, it was confirmed that the particle sizes all increased during the nitriding process.

Accordingly, it was confirmed that the particle size of the core-shell catalyst was in the range of 3 nm to 5 nm.

### Experimental Embodiment 2. Structural Analysis Results (XRD, ICP, EA) of M@Pt/C (M=Y, La, Ce, Zn, Mn) Catalyst

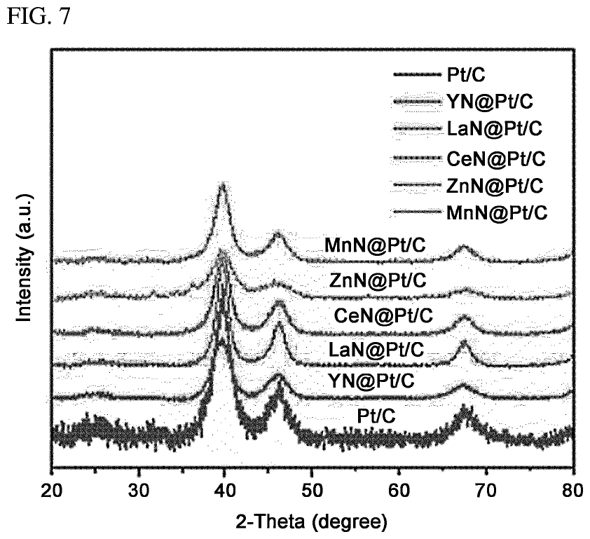

FIG. 7 illustrates a structural analysis result of a core-shell catalyst with improved durability according to an exemplary embodiment of the present disclosure.

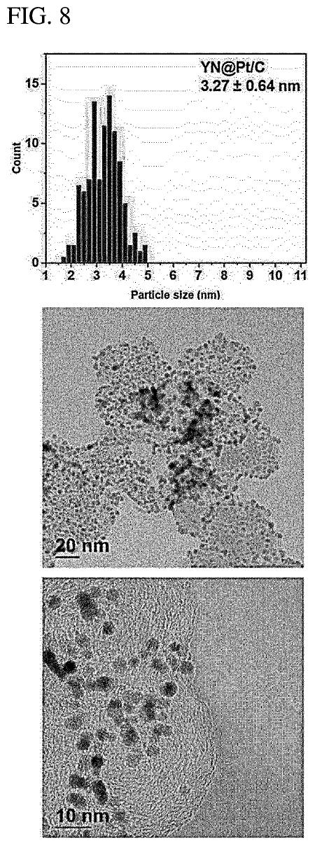

FIG. 8 illustrates a catalytic analysis result of a core-shell catalyst with improved durability according to an exemplary embodiment of the present disclosure.

TABLE 6

| | Crystallite | Pt—Pt | (111) Peak |
|---|---|---|---|
| Sample | size (111) (nm) | distance (nm) | position (°) |
| Pt/C | 3.14 | 0.2781 | 39.65 |
| YN@Pt/C | 3.37 | 0.2787 | 39.56 |
| LaN@Pt/C | 4.94 | 0.2780 | 39.67 |
| CeN@Pt/C | 3.96 | 0.2785 | 39.65 |
| ZnN@Pt/C | 2.31 | 0.2785 | 39.66 |
| MnN@Pt/C | 3.62 | 0.2781 | 39.66 |

TABLE 7

| | Metal | | | | | | | | | | | |
|---|---|---|---|---|---|---|---|---|---|---|---|---|
| | loading | | Elemental content | | | | | Atom content | | | | |
| | ICP | | EA | | | | | ICP | | | | |
| | (wt %) | | (wt %) | | | | | (at %) | | | Pt/M | M/N |
| | Pt | M | N | C | H | S | O | Pt | M | N | Ratio | Ratio |
| YN@Pt/C | 32.73 | 3.93 | 0.70 | 57.79 | 0.31 | 0.23 | 4.18 | 64.1 | 16.9 | 19.0 | 3.8 | 0.9 |
| LaN@Pt/C | 36.38 | 1.25 | 0.45 | 59.97 | 0.23 | 0.20 | 1.82 | 81.9 | 4.0 | 14.1 | 20.5 | 0.3 |
| CeN@Pt/C | 35.10 | 2.10 | 0.56 | 59.91 | 0.21 | 0.24 | 2.40 | 76.6 | 6.4 | 17.0 | 12.0 | 0.4 |
| ZnN@Pt/C | 31.93 | 6.58 | 1.11 | 55.94 | 0.27 | 0.23 | 3.51 | 47.6 | 29.3 | 23.1 | 1.6 | 1.3 |
| MnN@Pt/C | 34.04 | 3.71 | 0.77 | 58.74 | 0.16 | 0.25 | 2.30 | 58.8 | 22.7 | 18.5 | 2.6 | 1.2 |

Referring to Tables 6 and 7 above, through ICP and EA analysis results, it was confirmed that all synthesized core-shell catalysts contained nitrogen (0.45 to 1.11 wt %). In addition, it was confirmed that the smaller the particle size and the higher the transition metal (M) content, the higher the nitriding level.

### Experimental Embodiment 3. Particle Size Uniformity and Dispersion Analysis of M@Pt/C (M=Y, La, Ce, Zn, Mn) Catalyst

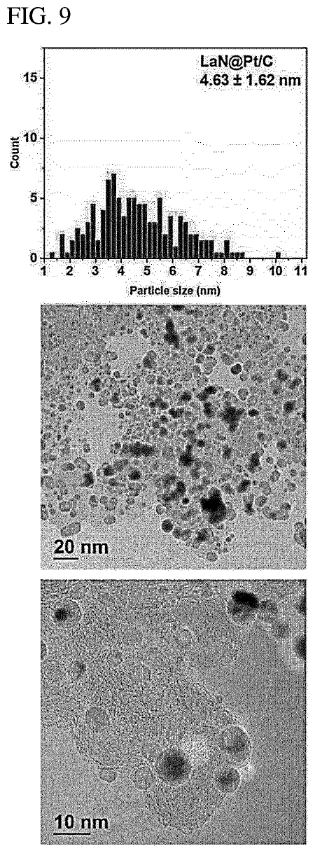

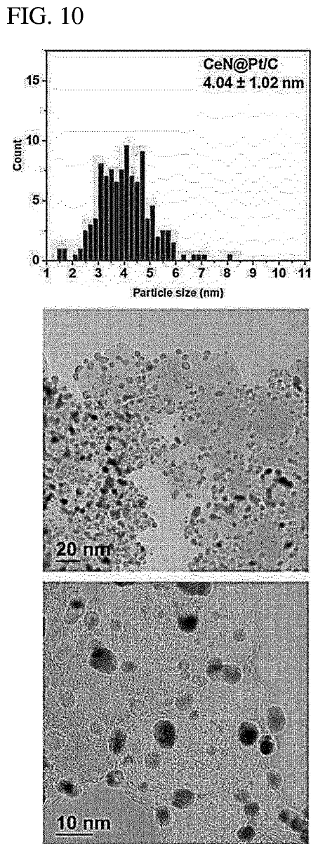

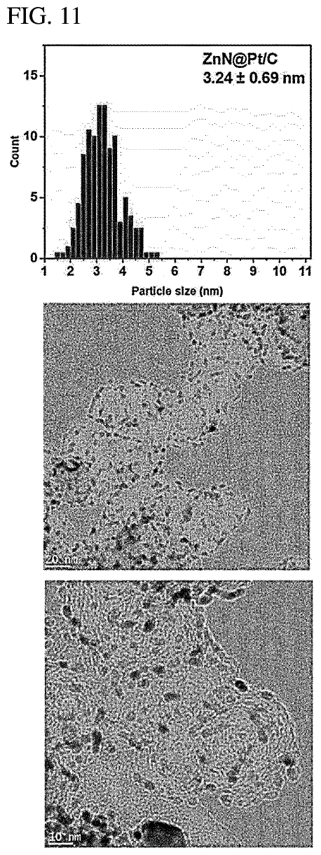

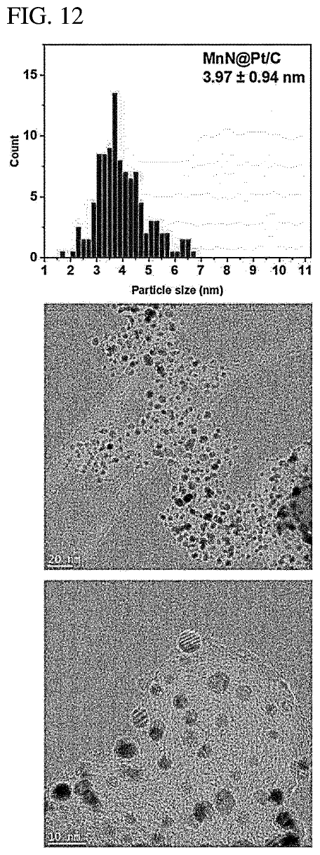

FIGS. 9 to 12 illustrate particle size uniformity and dispersion of a core-shell catalyst with improved durability according to an exemplary embodiment of the present disclosure.

In Experimental Embodiment, particle size uniformity and dispersion analysis of the core-shell catalysts with improved durability was conducted.

Referring to FIGS. 9 to 12, it was confirmed that the core-shell catalyst with improved durability according to an exemplary embodiment of the present disclosure had a particle size of 3 nm to 5 nm, and uniformity and dispersion were evenly consistent.

### Experimental Embodiment 4. Performance and Durability Evaluation Results of M@Pt/C (M=Y, La, Ce, Zn, Mn) Catalyst

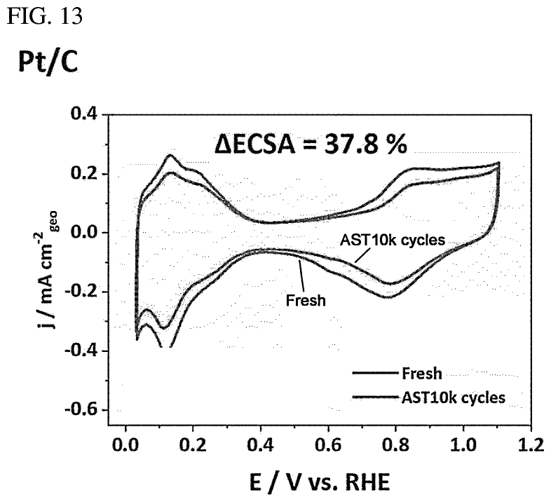

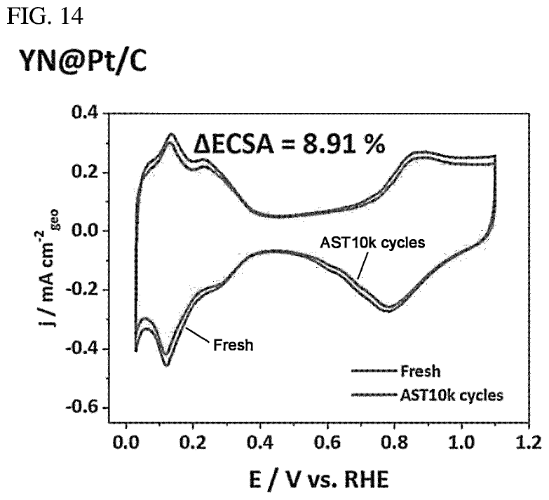

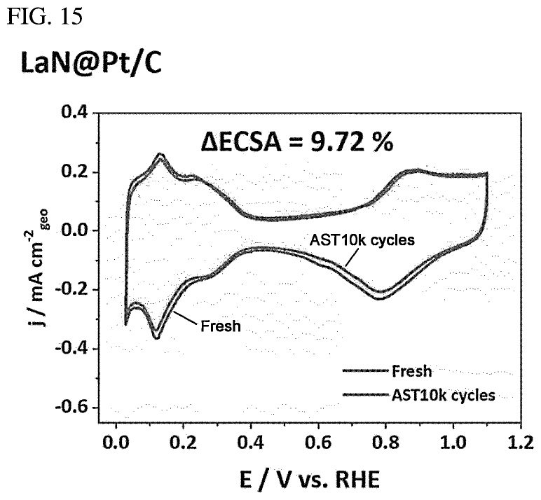

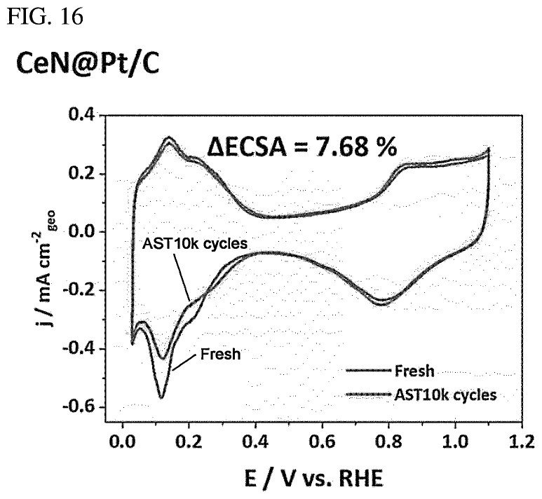

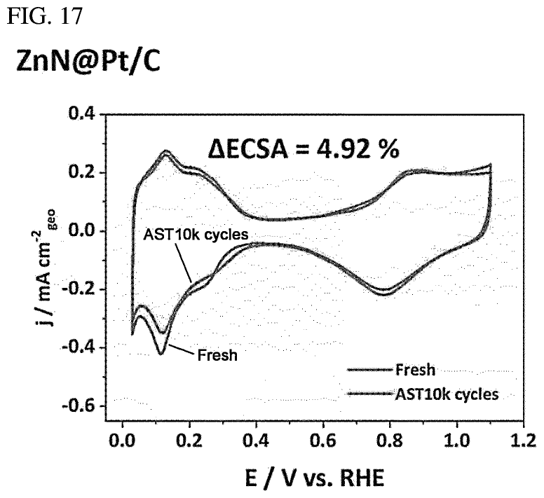

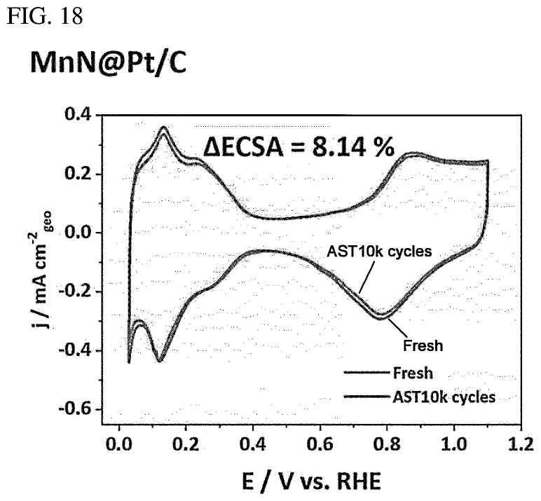

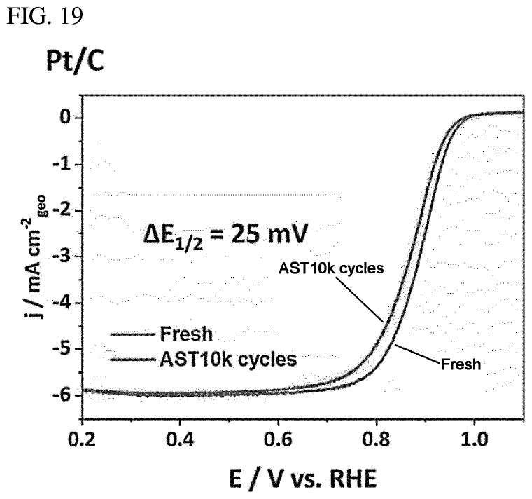

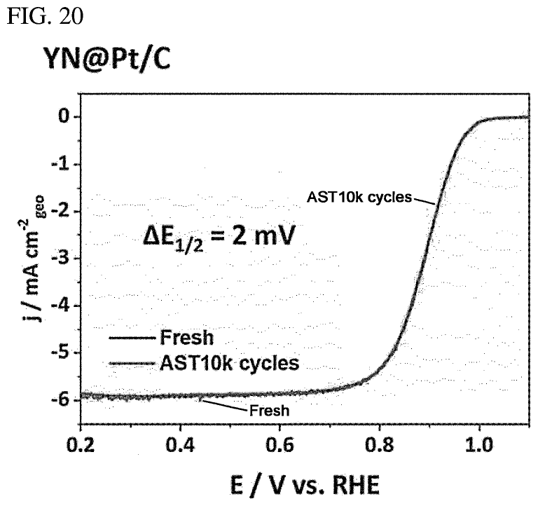

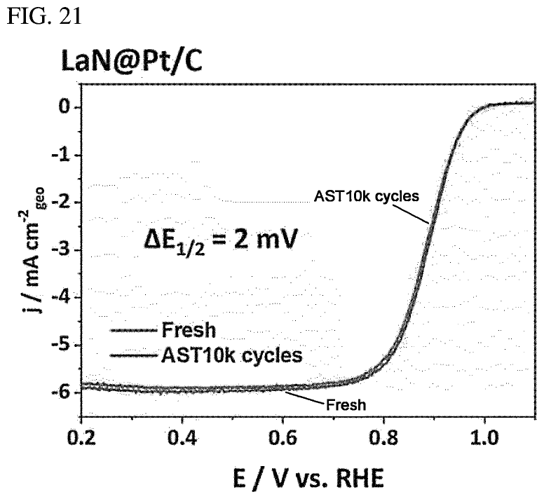

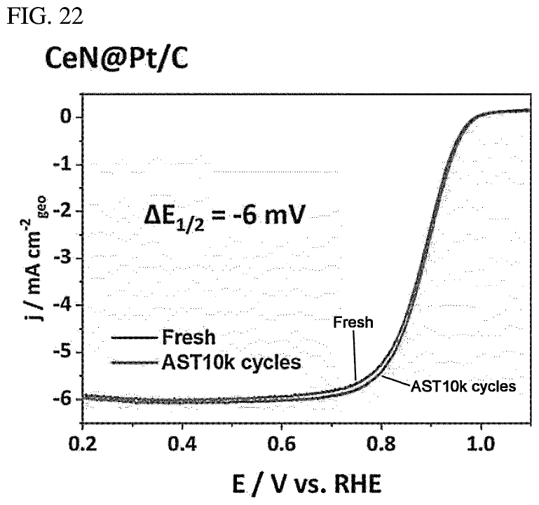

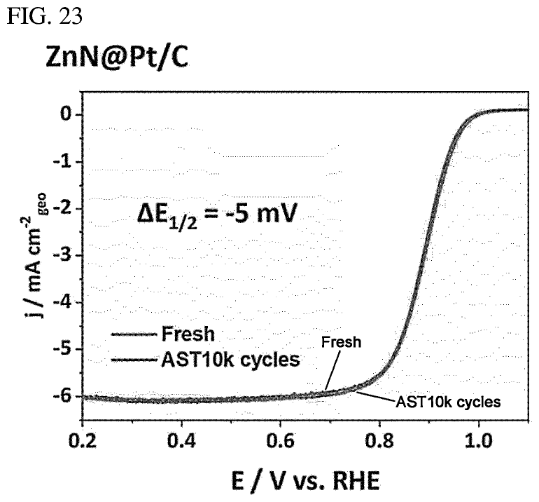

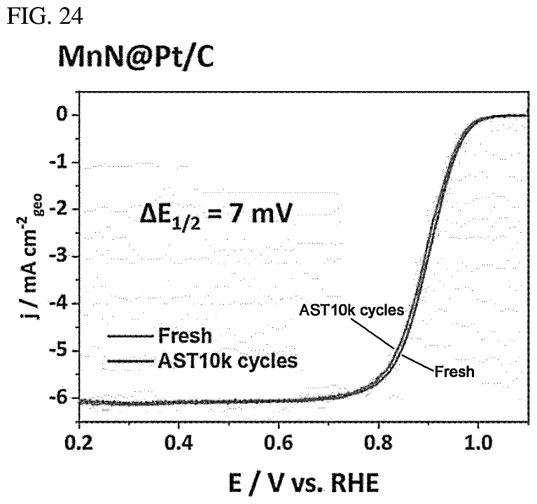

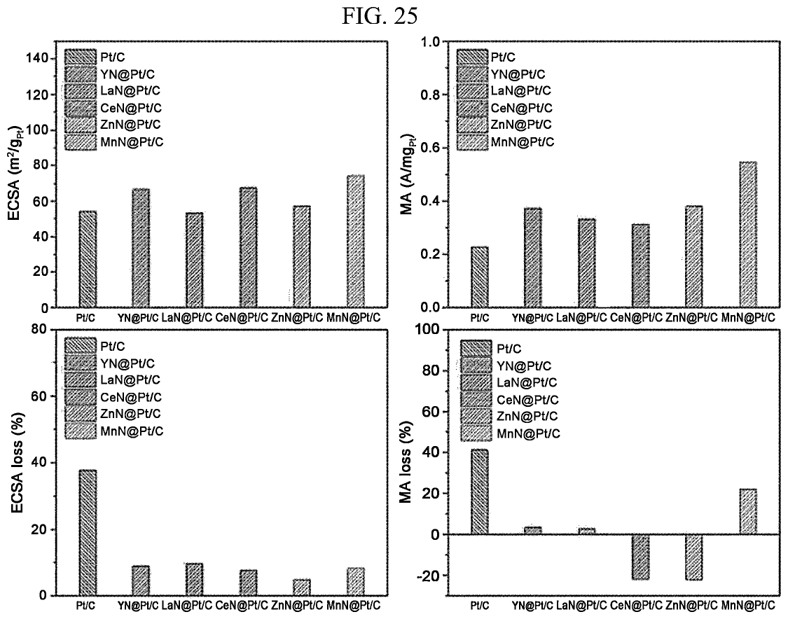

FIGS. 13 to 25 illustrate catalyst performance and durability evaluation results of a core-shell catalyst with improved durability according to an exemplary embodiment of the present disclosure.

In Experimental Embodiment, the catalytic performance and durability of the core-shell catalyst with improved durability were evaluated, and the results were shown in Tables 8 to 13 below.

TABLE 8

| Sample | ECSA (m²/g) | MA (A/mgₚₜ) | SA (uA/cm²) | E_{1/2} (mv) |
|---|---|---|---|---|
| Pt/C- | 54 | 0.226 | 418.6 | 888 |
| Fresh | | | | |
| Pt/C-AST | 33.6 | 0.133 | 393.1 | 863 |
| 10k | (37.8%) | (41.2%) | (6.1%) | (25 mV) |

TABLE 9

| Sample | ECSA (m²/g) | MA (A/mgₚₜ) | SA (uA/cm²) | E_{1/2} (mv) |
|---|---|---|---|---|
| YN@Pt/C- | 66.30 | 0.372 | 561.1 | 907 |
| Fresh | | | | |
| YN@Pt/C- | 60.40 | 0.360 | 594.9 | 905 |
| AST 10k | (8.91%) | (3.42%) | (−6.03%) | (2 mV) |

TABLE 10

| Sample | ECSA (m²/g) | MA (A/mgₚₜ) | SA (uA/cm²) | E_{1/2} (mv) |
|---|---|---|---|---|
| LaN@Pt/C- | 53.06 | 0.332 | 625.3 | 904 |
| Fresh | | | | |
| LaN@Pt/C- | 47.90 | 0.323 | 673.9 | 902 |
| AST 10k | (9.72%) | (2.70%) | (−7.77%) | (2 mV) |

TABLE 11

| Sample | ECSA (m²/g) | MA (A/mgₚₜ) | SA (uA/cm²) | E_{1/2} (mv) |
|---|---|---|---|---|
| CeN@Pt/C- | 67.07 | 0.312 | 465.3 | 900 |
| Fresh | | | | |
| CeN@Pt/C- | 61.92 | 0.380 | 614.3 | 906 |
| AST 10k | (7.68%) | (−21.9%) | (−32.0%) | (−6 mV) |

TABLE 12

| Sample | ECSA (m²/g) | MA (A/mgₚₜ) | SA (uA/cm²) | E_{1/2} (mv) |
|---|---|---|---|---|
| ZnN@Pt/C- | 57.14 | 0.379 | 663.0 | 905 |
| Fresh | | | | |
| ZnN@Pt/C- | 54.33 | 0.462 | 851.1 | 910 |
| AST 10k | (4.92%) | (−22.1%) | (−28.37%) | (−5 mV) |

TABLE 13

| Sample | ECSA (m²/g) | MA (A/mgₚₜ) | SA (uA/cm²) | E_{1/2} (mv) |
|---|---|---|---|---|
| MnN@Pt/C- | 74.05 | 0.546 | 736.8 | 915 |
| Fresh | | | | |
| MnN@Pt/C- | 68.02 | 0.425 | 624.7 | 908 |
| AST 10k | (8.14%) | (22.1%) | (15.2%) | (7 mV) |

In Tables 8 to 13, the numbers in parentheses all indicate change rates, and the sign (−) indicates an increase in catalyst performance after durability evaluation.

Referring to Tables 8 to 13 above, it was found that compared to a commercial Pt/C catalyst, all catalysts showed high ECSA, MA, SA, and E_{1/2} values, which indicated increased performance depending on alloying and nitriding.

In addition, after evaluating the deterioration of the core-shell catalyst (AST 10k), it was found that the durability of the M@Pt/C catalyst was improved due to lower ECSA and MA reduction rates than the commercial catalyst.

Among the core-shell catalysts with improved durability of the present disclosure, CeN@Pt/C and ZnN@Pt/C catalysts showed a tendency for increased performance after durability evaluation.

It is expected that impurities on the catalyst surface were removed during the durability evaluation process to form a complete core-shell structure, and then platinum was more clearly exposed on the surface, thereby increasing catalyst performance.

As such, the core-shell catalyst with improved durability manufactured by nitriding according to the present disclosure has a high nitrogen content in the core to have a small average particle size and high dispersion and uniformity while having excellent durability of the prepared catalyst.

Further, the core-shell catalyst with improved durability manufactured by nitriding may be obtained in large quantities because the production process is easy.

Accordingly, the core-shell catalyst of the present disclosure is expected to contribute greatly to the commercialization of fuel cells when applied as an electrode catalyst with high oxygen reduction reaction efficiency.

Further, the present disclosure has an advantage that the nitrided core-shell catalyst has a lower reduction rate in catalytic performance than a commercial platinum catalyst even after evaluation of durability to have very high durability of the core-shell catalyst.

The above description just illustrates the technical spirit of the present disclosure and various changes and modifications can be made by those skilled in the art to which the present disclosure pertains without departing from an essential characteristic of the present disclosure. The protective scope of the present disclosure should be construed based on the following claims, and all the technical ideas in the equivalent scope thereof should be construed as falling within the scope of the present disclosure.

What is claimed is:

1. A manufacturing method of a core-shell catalyst with improved durability comprising:
irradiating ultrasonic waves to a solution containing a reducing solvent, a noble metal precursor, a transition metal precursor, and a carbon support to form a cavity due to the irradiation of the ultra-waves and forming transition metal precursor core and noble metal precursor shell particles due to a difference in vapor pressure; and
nitriding the transition metal precursor core and noble metal precursor shell particles by heat-treating at a predetermined temperature and pressurizing a predetermined pressure condition under a gaseous nitrogen source,
wherein the transition metal is any one selected from the group consisting of Y, La, Ce, Zn, and Mn or combinations thereof.

2. The manufacturing method of the core-shell catalyst with improved durability of claim 1, wherein the gaseous nitrogen source is selected from the group consisting of ammonia, urea, and melamine, and
the predetermined temperature and the predetermined pressure condition are a temperature of 450 to 900° C. and a pressure condition of 1 to 120 bar, respectively.

3. The manufacturing method of the core-shell catalyst with improved durability of claim 1, wherein the core-shell particle contains 0.45 to 1.11 wt % of nitrogen.

4. The manufacturing method of the core-shell catalyst with improved durability of claim 1, wherein the core-shell catalyst has a ratio (M/N Ratio) of a transition metal and nitrogen of 0.3 to 1.3.

5. A core-shell catalyst with improved durability comprising:
a transition metal core; and
a noble metal shell surrounding the transition metal core,
wherein the transition metal is any one selected from the group consisting of Y, La, Ce, Zn, and Mn or combinations thereof.

6. The core-shell catalyst with improved durability of claim 5, wherein the core-shell catalyst is nitrided to improve durability.

7. The core-shell catalyst with improved durability of claim 5, wherein the core-shell particle contains 0.45 to 1.11 wt % of nitrogen.

8. The core-shell catalyst with improved durability of claim 5, wherein the core-shell catalyst has a ratio (M/N Ratio) of a transition metal and nitrogen of 0.3 to 1.3.

9. The core-shell catalyst with improved durability of claim 5, wherein the core-shell catalyst has a reduction rate in electrochemical surface area (ECSA) lower than that of a commercial platinum catalyst after evaluation of accelerated durability (0.6 V (3 s) to 0.95 V (3 s), 10,000 cycles).

10. The core-shell catalyst with improved durability of claim 5, wherein the core-shell catalyst has a reduction rate in mass activity (MA) lower than that of a commercial platinum catalyst after evaluation of accelerated durability (0.6 V (3 s) to 0.95 V (3 s), 10,000 cycles).

11. The core-shell catalyst with improved durability of claim 5, wherein the core-shell catalyst has a reduction rate in half wave potential (E ½) lower than that of a commercial platinum catalyst after evaluation of accelerated durability (0.6 V (3 s) to 0.95 V (3 s), 10,000 cycles).
